(19) United States
(12) Patent Application Publication
(10) Pub. No.: US 2024/0136667 A1
(43) Pub. Date: Apr. 25, 2024

(54) Method for Electrically Connecting an Energy Storage Cell, and Electrical Energy Storage Cell

(71) Applicant: Bayerische Motoren Werke Aktiengesellschaft, Muenchen (DE)

(72) Inventor: Viktor DUPPER, Muenchen (DE)

(21) Appl. No.: 18/278,672

(22) PCT Filed: Feb. 16, 2022
(86) PCT No.: PCT/EP22/53722

§ 371 Date: Aug. 23, 2023

(30) Foreign Application Priority Data
Mar. 15, 2021 (DE) 10 2021 106 349.3

(51) Int. Cl. H01M 50/516; B23K 9/007

(52) U.S. Cl. CPC H01M 50/516; B23K 9/007; B23K 2101/38

(57) ABSTRACT

A method for electrically connecting an energy storage cell includes providing at least one electrical energy storage cell, comprising a first connecting pole, arranging the first connecting pole and a first contact element to each other for forming a first contact point and closing an electrical circuit over the at least one energy storage cell and utilizing the electrical energy stored in the energy storage cell for producing a welding connection at the first contact point.

### FIELD

The present invention relates to a method for electrically connecting or contacting an energy storage cell, and to an electrical energy store.

### BACKGROUND AND SUMMARY

High-voltage stores or traction batteries of electrically driven motor vehicles comprise a large number of energy storage cells, which are electrically interconnected. In practice, the production of the large number of electrical contacts that have to be created here is laborious. Welding methods are typically used in this context. For example, DE 10 2017 004 939 A1 discloses a method for electrically conductively connecting the electrical poles of at least two battery cells of a battery for a motor vehicle to one another via a cell connector plate by means of ultrasonic bonding or ultrasonic welding. Welding methods of this kind have the disadvantage that a certain degree of accessibility has to be provided in order to be able to actually carry out the welding process. In addition, hundreds of cells may have to be welded in a typical high-voltage store, this requiring a great deal of effort in production.

Therefore, an object of the present invention is to specify a method for electrically connecting an energy storage cell and to specify an electrical energy store, which method and electrical energy store overcome the abovementioned disadvantages and in so doing provide potential for a reduction in costs.

This object is achieved by a method according to the present disclosure and by an electrical energy store also according to the present disclosure. Further advantages and features can be found in the description and in the appended figures.

According to the invention, a method for electrically connecting an or at least one energy storage cell comprises the steps of:
providing at least one electrical energy storage cell, comprising a first connection pole;
arranging the first connection pole and a first contact element against one another to form a first contact point;
closing an electrical circuit across the at least one energy storage cell and using the electrical energy stored in the energy storage cell to produce a welding connection at the first contact point.

The method is therefore, in particular, a method for welding the at least one energy storage cell to at least one first contact element. In this case, the welding process is advantageously based on the principle of bolt welding. The respective energy storage cell expediently acts as a “bolt”, with the tip of the bolt being formed by the connection pole of the respective energy storage cell. The energy contained in the energy storage cell is expediently used for welding said energy storage cell to the first contact element. The energy required for welding therefore does not come from the outside or is not supplied externally, but rather is provided directly by the at least one energy storage cell. The electrical circuit, in which the at least one energy storage cell serves as a voltage source, is constructed in order to generate the current flow required for welding. A suitable current drain is expediently provided for drawing current. Examples will be discussed later.

According to a preferred embodiment, a large number energy storage cells are provided. Preferred types of energy storage cells are, without limiting the generality, lithium-ion cells, lithium-sulfur cells or iron-phosphate cells, amongst others. Energy storage cells can also be capacitors or supercaps. The energy storage cells preferably form an energy store or an energy storage module. In the present case, the energy storage cells or the energy store or the energy storage module is expediently connected in such a way that energy can be drawn. Here, the current flow generates a temperature increase at the contact points in such a way that welding takes place. The at least one energy storage cell is therefore initially only precontacted in a first step. The actual, in particular cohesive, connection/contacting takes place only in a next step.

According to a preferred embodiment, the method comprises the step of:
precharging the at least one energy storage cell to a defined level.

Expediently, the at least one energy storage cell is precharged or a precharged energy storage cell is provided.

An electronic load is preferably provided in the electrical circuit for load take-up. An electronic load is a device or an assembly which is used as a replacement for a conventional (non-reactive) load resistor. Expediently, electrical power can be drawn from the electronic load. As an alternative, one or more constant resistances can also be introduced into the electrical circuit. Both the resistances and the electronic load should be selected or set in such a way that the current flowing in the electrical circuit is sufficient to produce the welding connection.

The method expediently comprises the step of:
establishing the welding connection by producing an arc.

An arc is preferably ignited between the first connection pole and the first contact element, the arc melting the first connection pole and/or the first contact element, as a result of which a welding pool is created.

The method expediently comprises the step of:
providing a raised welding portion in the region of the first contact point to produce, in particular start, an or the arc.

The raised welding portion is formed directly on the first connection pole according to a preferred embodiment. As an alternative or in addition, the raised welding portion can also be formed on the first contact element. The raised welding portion contacts the other element, that is to say for example the first contact element or, conversely, the first connection pole, and serves in particular as a starting point for the arc. The first connection pole is initially spaced apart from the first contact element by the length of the raised welding portion. After the arc has been ignited, the first connection pole and the first contact element move toward each other until they make contact with one another.

In order to produce the arc without a raised welding portion, the method is conducted in such a way that the first connection pole and the first contact element re initially in contact with one another. In this position, the current flow is produced. The arc that is critical for fusing is formed by way of the first connection pole moving away from the first contact element, or vice versa. After the arc has been ignited, the first connection pole and the first contact element move toward each other until they make contact with one another.

According to one embodiment, the method comprises the step of:
using additional material in the region of the first contact point.

The additional material can serve as additional welding material. The additional material can be designed to increase an electrical resistance in the first contact point in order to possibly generate an additional increase in temperature. Further as an alternative, the additional material can be used in order to form the abovementioned raised welding portion. The additional material can accordingly be formed on the first connection pole and/or on the first contact element.

According to one embodiment, the energy storage cell is provided with the raised welding portion on its positive pole. According to one embodiment, the first connection pole is accordingly the positive pole or the positive terminal. As mentioned, the raised welding portion preferably acts as an initiator to initiate the welding connection. The raised welding portion is designed as a, for example cylindrical, projection with a correspondingly small diameter for this purpose. When the electrical circuit is closed, this geometry leads to a sharp increase in temperature and to the above-described effects.

In order to contact the first connection pole and the first contact element after the arc has been ignited, the energy storage cell is shifted or adjusted in the direction of the first contact element according to one preferred embodiment.

According to one embodiment, the method comprises the step of:
pretensioning the arrangement comprising the at least one energy storage cell and the first contact element by means of the arrangement of an additional element, which presses the first connection pole and the first contact element against one another.

The additional element can be a device which is designed to press the first connection pole and the first contact element, in particular actively, against one another. As an alternative, the additional element can be a structural element, in particular for example a component or structural element of an energy storage housing, in which the at least one energy storage cell is arranged.

According to a preferred embodiment, the abovementioned “adjustment” can be implemented via a second contact element, which is arranged on the respective energy storage cell, in order to contact a second connection pole, for example. According to one embodiment, the second contact element is formed as a preferably resilient, for example metal, tab, which is designed and suitable for applying the force required to press the first connection pole and the first contact element together.

The second connection pole and the second contact element form a second contact point.

According to one embodiment, the method comprises the step of:
arranging a large number of energy storage cells, comprising first connection poles and second connection poles, in an arrangement structure and forming a large number of first contact points in so doing.

According to one embodiment, the arrangement structure comprises a large number of first contact elements. These can be automatically contacted when the energy storage cells are arranged in the arrangement structure. It is particularly advantageous here that subsequent accessibility for welding does not have to be provided.

According to one embodiment, the arrangement structure comprises, for example, a large number of arrangement regions, which are matched to a housing geometry of the energy storage cells. The arrangement regions are, for example, prismatic or cylindrical. The contact elements can be arranged or embedded in the arrangement structure. As an alternative, a cell contacting system, comprising a large number of first contact elements, is provided and arranged on the arrangement structure.

According to one embodiment, the method comprises the step of:
positive and non-positive contacting of the second connection pole of the at least one energy storage cell or the second connection poles of the large number of energy storage cells.

As already mentioned, the second contact elements can be formed, for example, as spring elements.

According to one embodiment, the second contact elements are constituent parts of a supporting structure, which is designed to be arranged on the at least one energy storage cell or on the large number of energy storage cells. The supporting structure can be part of a or the cell contacting system. The energy storage cells can be automatically pretensioned by means of the arrangement of the supporting structure on the energy storage cells.

The actual structural design is in particular also dependent on the shape of the energy storage cell.

Preferred cell shapes are, for example, (cylindrical) round cells. According to one embodiment, these have the first connection pole at one end, and the second connection pole at the opposite end. According to one embodiment, an energy storage cell of this kind is, preferably positively, inserted into an arrangement structure, with a first contact element being contacted at the same time. Following this, the second connection pole is connected to a second connection pole, it possible here for the cell to already be pretensioned, as already mentioned. As an alternative, the round cell has both connection poles at one end. The situation is similar for prismatic cells, which likewise generally have both connection poles on one side, preferably in particular on the cover.

The invention also relates to an electrical energy store, such as a high-voltage store or a traction battery or else a battery module for example, comprising a large number of energy storage cells, which are connected or contacted, in particular welded, in line with the method according to the invention.

Further advantages and features can be gathered from the following description of exemplary embodiments of the method with reference to the appended figures.

### BRIEF DESCRIPTION OF THE DRAWINGS

FIG. 1 shows a schematically illustrated method sequence for welding;

FIG. 2 shows schematic views for understanding the method sequence; and

FIG. 3 shows a schematic view of two energy storage cells, arranged in an arrangement structure.

### DETAILED DESCRIPTION

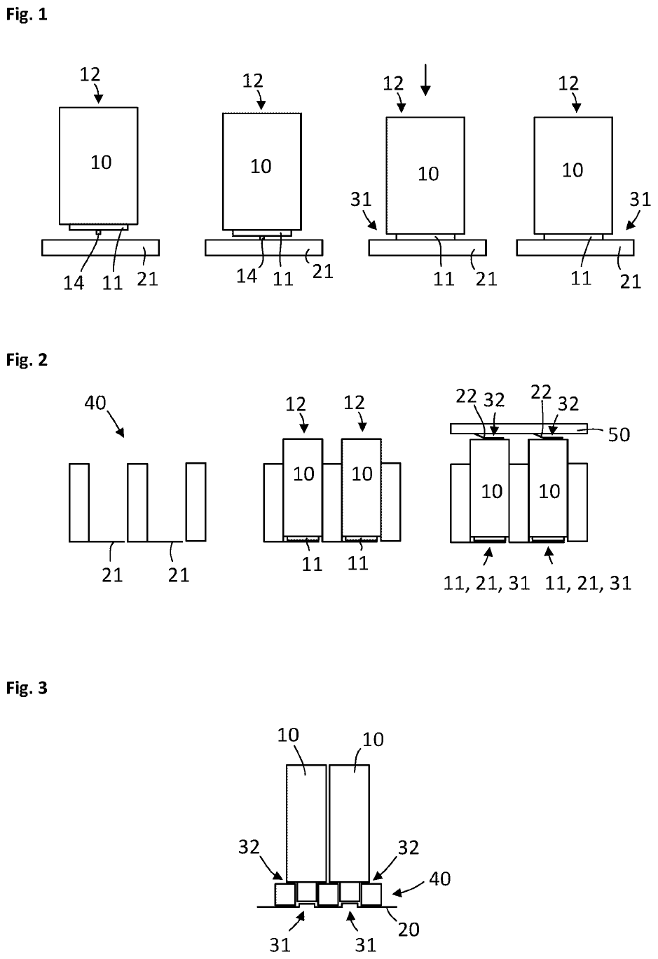

FIG. 1 shows, in a view on the left, an energy storage cell 10, comprising a first connection pole 11 and a second connection pole 12 arranged opposite. In the present case, the energy storage cell 10 is shown as a so-called round cell. A raised welding portion 14 is formed in the region of the first connection pole 11. The first connection pole 11 is, for example, the positive pole. The raised welding portion 14 or tip serves as a welding element for welding to a first contact element 21. The basic idea is that the energy storage cell 10 is precharged to a specific level and the energy contained in the energy storage cell 10 is directly used to weld the first connection pole 11 and the first contact element 21 to one another. For this purpose, the energy storage cell 10, cf. the second view, is led to the first contact element 21, so that the first contact element contacts the raised welding portion 14. When the energy storage cell 10 is discharged, the raised welding portion begins to melt and a welding pool is formed in the region of a first contact point 31. The raised welding portion 14 serves, in particular, to start an arc. The arrow in the third image indicates that the energy storage cell 10 is adjusted in the direction of the first contact element 21. Once the method is concluded, the energy storage cell 10 is securely welded in the region of the first contact point 31.

FIG. 2 schematically shows an arrangement structure 40, which comprises first contact elements 21. Schematically illustrated round cells 10, comprising first connection poles 11 and second connection poles 12, are arranged in the arrangement structure 40 and contact the first contact elements 21. Accordingly, first contact points 31 are formed. The entire arrangement can be pretensioned by means of the arrangement of a supporting structure 50, which for its part comprises a corresponding large number of second contact elements 22. For this purpose, the supporting structure 50 is accordingly arrested, for example in a housing, not illustrated further here. The second connection poles 12 form second contact points 32 with the second contact elements 22. In the present case, the second contact elements 22 are formed, for example, as resilient tabs, which are designed to apply a force to the energy storage cells 10 in order to shift them in the direction of the first contact elements 21 or to provide the contacting. When the energy storage cells 10 are discharged, welding can thereby be performed, as it were automatically.

FIG. 3 shows, in a further schematic illustration, two energy storage cells 10 which are formed as round cells and are arranged in an arrangement structure 40. In the present case, reference sign 20 denotes a cell contacting system, which is formed, for example, as a leadframe. This comprises a large number of first contact elements, which form first contact points 31 with the corresponding first connection poles of the energy storage cells 10. In the energy storage cells shown in FIG. 3, the second connection poles are formed on the same side as the first connection poles. Accordingly, second contact points 32 are formed in the region of the arrangement structure 40.

### LIST OF REFERENCE SIGNS

10 Energy storage cell
11 First connection pole
12 Second connection pole
14 Raised welding portion
20 Cell contacting system
21 First contact element
22 Second contact element
31 First contact point
32 Second contact point
40 Arrangement structure
50 Supporting structure

1-10. (canceled)

11. A method for electrically connecting an energy storage cell, comprising:
providing at least one electrical energy storage cell comprising a first connection pole;
arranging the first connection pole and a first contact element against one another to form a first contact point;
closing an electrical circuit across the at least one energy storage cell and using electrical energy stored in the energy storage cell to produce a welding connection at the first contact point.

12. The method according to claim 11, comprising:
precharging the at least one energy storage cell to a defined level.

13. The method according to claim 11, comprising:
providing an electronic load in the electrical circuit for load take-up.

14. The method according to claim 11, comprising:
establishing the welding connection by producing an arc.

15. The method according to claim 11,
providing a raised welding portion in a region of the first contact point to produce or start an arc.

16. The method according to claim 11, comprising:
using additional material in a region of the first contact point.

17. The method according to claim 11, comprising:
pretensioning an arrangement comprising the at least one energy storage cell and the first contact element using an additional element that presses the first connection pole and the first contact element against one another.

18. The method according to claim 11, comprising:
arranging a plurality of energy storage cells, each comprising first connection poles and second connection poles, in an arrangement structure and forming a plurality of first contact points in so doing.

19. The method according to claim 11, comprising:
positive and non-positive contacting of the second connection pole of the at least one energy storage cell.

20. An electrical energy store, comprising:
a plurality of energy storage cells; wherein each of the plurality of energy storage cells comprises at least a first connection pole; and
at least one first contact element, wherein the first connection pole of each of the plurality of energy storage cells is contacted against the at least one first contact element to form a plurality of first contact points; and
a plurality of welding connections at the plurality of first contact points formed by closing an electrical circuit across the plurality of energy storage cells and using electrical energy stored in the plurality of energy storage cells to produce the plurality of welding connections.

21. The electrical energy store according to claim 20, comprising:
an electronic load in the electrical circuit for load take-up.

22. The electrical energy store according to claim 20,
wherein the plurality of welding connects are established by producing an arc.

23. The electrical energy store according to claim 20, comprising:
a plurality of raised welding portions in regions of the plurality of first contact points to produce or start an arc.

24. The electrical energy store according to claim 20, comprising:
additional material in regions of the plurality of first contact points.

25. The electrical energy store according to claim 20, comprising:
at least one additional element configured to pretension an arrangement comprising the plurality of energy storage cells and at least one first contact element that presses the plurality of first connection poles and the at least one first contact element against one another.

26. The electrical energy store according to claim 20,
wherein the plurality of energy storage cells each comprise a second connection pole.
